(19) United States
(12) Patent Application Publication
(10) Pub. No.: US 2006/0145541 A1
(43) Pub. Date: Jul. 6, 2006

(54) Methods and apparatus for generating a multi-position control

(76) Inventors: Kerfegar K. Katrak, Fenton, MI (US); Paul A. Bauerle, Fenton, MI (US); Donald A. Eveleth, Highland, MI (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 11/029,635

(22) Filed: Jan. 5, 2005

(51) Int. Cl. H01H 33/59

(52) U.S. Cl. 307/139

(57) ABSTRACT

Systems, methods and devices are described for determining a state of a multi-position actuator such as a four-state switch with a return-to-default position. A circuit for detecting the state of the multi-position actuator suitably includes two or more switches coupled to the actuator and configured to provide input signals as a function of the state of the actuator. At least one of the switches is a ternary (three-state) switch to increase the number of states that can be represented. Control logic receives the input signals from the switches and determines the state of the multi-position actuator as a function of the input signals. This circuit is useful in a number of automotive and other applications, including joysticks, transfer case controls, electric mirror controls, power take-off (PTO) and other devices.

### TECHNICAL FIELD

The present invention generally relates to multi-state switching logic, and more particularly relates to methods, systems and devices for generating a multi-position control.

### BACKGROUND OF THE INVENTION

Modern vehicles contain numerous electronic and electrical switches. Vehicle features such as climate controls, audio system controls other electrical systems and the like are now activated, deactivated and adjusted in response to electrical signals generated by various switches in response to driver/passenger inputs, sensor readings and the like. These electrical control signals are typically relayed from the switch to the controlled devices via copper wires or other electrical conductors. Presently, many control applications use a single wire to indicate two discrete states (e.g. ON/OFF, TRUE/FALSE, HIGH/LOW, etc.) using a high or low voltage transmitted on the wire.

To implement more than two states, typically additional control signals are used. In a conventional two/four wheel drive transfer control, for example, four active states of the control (e.g. 2WD mode, auto 4WD mode, 4WD LO mode and 4WD HI mode) as well as a default mode are represented using three to five discrete two-state switches coupled to a single or dual-axis control lever. As the lever is actuated, the various switches identify the position of the lever to place the vehicle in the desired mode. Conventional electric mirror controls similarly use three or more discrete switches to represent directions of mirror movement indicated on a stick or similar controller. Power take-off (PTO) controls also typically contain three or more discrete switches to represent the various states of the PTO device, which is commonly used to power upfitter-installed accessories such as bucket lifts, snow plows, lift dump bodies and the like. Numerous other multi-state switches use multiple discrete switches to represent the various positions of a single or dual-axis control mechanism, which in turn represent the various states of a controlled component of the vehicle.

As consumers demand additional electronic features in newer vehicles, the amount of wiring present in the vehicle continues to increase. This additional wiring occupies valuable vehicle space, adds undesirable weight to the vehicle and increases the manufacturing complexity of the vehicle. There is therefore an ongoing need in vehicle applications to reduce the amount of wiring in the vehicle without sacrificing features. Further, there is a need to increase the number of features in the vehicle without adding weight, volume or complexity commonly associated with additional wiring.

In particular, it is desirable to formulate multi-state switching devices such as those used in 2WD/4WD transfer case controls, electric mirror controls, power take off controls and the like that reduce the cost, complexity and weight associated with multiple input switches, wires and other components. Moreover, it is desirable to create a multi-position control with a return-to-default position using low cost and efficient techniques and components. Furthermore, other desirable features and characteristics will become apparent from the subsequent detailed description and the appended claims, taken in conjunction with the accompanying drawings and the foregoing technical field and background.

### SUMMARY OF THE INVENTION

Systems, methods and devices are described for determining and/or indicating the state of a multi-position actuator. According to one embodiment, a circuit for detecting the state of the multi-position actuator suitably includes two or more switches coupled to the actuator and configured to provide input signals as a function of the state of the actuator. One or more of the switches are ternary (three-state) switches to increase the number of states that can be represented. Control logic receives the input signals from the switches and determines the state of the multi-position actuator as a function of the input signals. This circuit is useful in a number of automotive and other applications, including joysticks, transfer case controls, electric mirror controls, power take off controls and other devices.

### BRIEF DESCRIPTION OF THE DRAWINGS

The present invention will hereinafter be described in conjunction with the following drawing figures, wherein like numerals denote like elements, and:

FIG. 1 is a block diagram of an exemplary vehicle;

FIG. 2 is a circuit diagram of an exemplary embodiment of a switching circuit;

FIG. 3 is a circuit diagram of an alternate exemplary embodiment of a switching circuit;

FIG. 4 is a circuit diagram of an exemplary switching circuit for processing input signals from multiple switches;

FIG. 5 is a logic diagram showing an exemplary five-state switching scheme suitable for use in a 2WD/4WD transfer control;

FIG. 6 is a logic diagram showing a second exemplary five-state switching scheme suitable for use in a 2WD/4WD transfer control;

FIG. 7 is a logic diagram showing an exemplary five-state switching scheme suitable for a power mirror control;

FIG. 8 is a logic diagram showing a second exemplary five-state switching scheme suitable for a power mirror control;

FIG. 9 is a logic diagram showing an exemplary five-state switching scheme suitable for a power take-off control;

FIG. 10 is a logic diagram showing a second exemplary five-state switching scheme suitable for a power take-off control;

FIG. 11A is a logic diagram showing an exemplary robust four-state switching scheme;

FIG. 11B is a logic diagram showing an exemplary robust four-state switching scheme;

FIG. 12 is a logic diagram showing an alternate embodiment of a four-state switching scheme; and

FIG. 13 is a logic diagram showing an alternate embodiment of a four-state switching scheme.

### DESCRIPTION OF THE PREFERRED EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

According to various exemplary embodiments, single and/or multi-axis controls for use in vehicles and elsewhere may be formulated with ternary switches to reduce the complexity of the control. Such switches may be used to implement robust and/or non-robust selection schemes for various types of control mechanisms, including those used for power mirrors, 2WD/4WD selectors, power take off controls and the like.

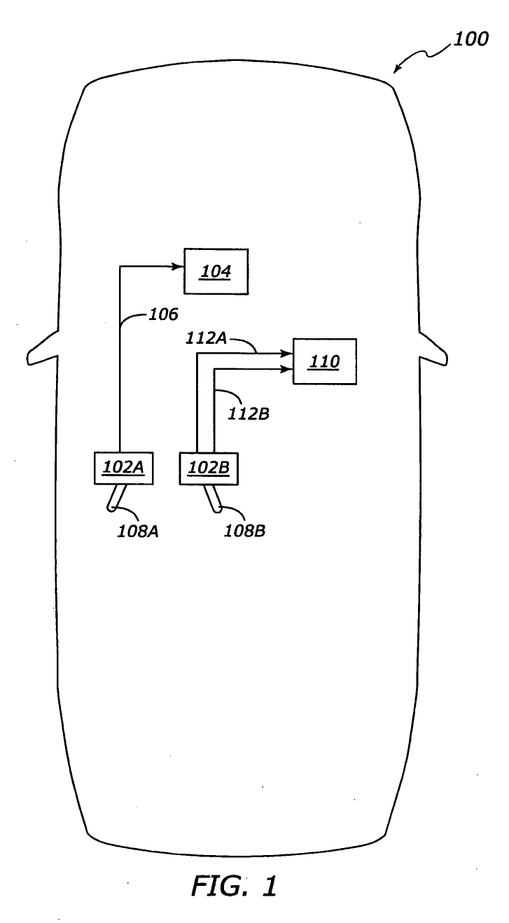

Turning now to the drawing figures and with initial reference to FIG. 1, an exemplary vehicle 100 suitably includes any number of components 104, 110 communicating with various switches 102A, 102B to receive control signals 106, 112A-B, respectively. The various components 104, 110 may represent any electric or electronic devices present within vehicle 100, including, without limitation, 2WD/4WD transfer case controls, windshield or other window controls, driver/passenger seat controls, power mirror selection and actuation devices, power take off selection/actuation devices, joysticks, multi-position selectors, digital controllers coupled to such devices and/or any other electrical systems, components or devices within vehicle 100.

Switches 102A-B are any devices capable of providing various logic signals 106, 112A-B to components 104, 110 in response to user commands, sensor readings or other input stimuli. In an exemplary embodiment, switches 102A-B respond to displacement or activation of a lever 108A-B or other actuator as appropriate. Various switches 102A-B may be formulated with electrical, electronic and/or mechanical actuators to produce appropriate ternary output signals onto a wire or other electrical conductor joining switches 102 and components 104, 110, as described more fully below. These ternary signals may be processed by components 104, 110 to place the components into desired states as appropriate. In various embodiments, a single ternary signal 106 may be provided (e.g. between switch 102A and component 104 in FIG. 1), and/or multiple signals 112A-B may be provided (e.g. between switch 102B and component 110 in FIG. 1), with logic in component 104 (or an associated controller) combining or otherwise processing the various signals 112A-B to extract meaningful instructions. In still further embodiments, binary, ternary and/or other signals may be combined in any suitable manner to create any number of switchable states.

Many types of actuator or stick-based control devices provide several output signals 112A-B that can be processed to determine the state of a single actuator 108B. Lever 108B may correspond to the actuator in a 2WD/4WD selector, electronic mirror control, power take off selector or other device operating within one or more degrees of freedom. Various degrees of movement may be provided with one or more guides that allow a hinged lever to move along an axis, for example, with multiple degrees of movement being provided with two or more guide axes. In alternate embodiments, lever 108A-B moves in a ball-and-socket or other arrangement that allows multiple directions of movement. The concepts described herein may be readily adapted to operate with any type of mechanical selector, including any type of lever, stick, or other actuator that moves with respect to the vehicle via any slidable, rotatable or other coupling (e.g. hinge, slider, ball-and-socket, universal joint, etc.).

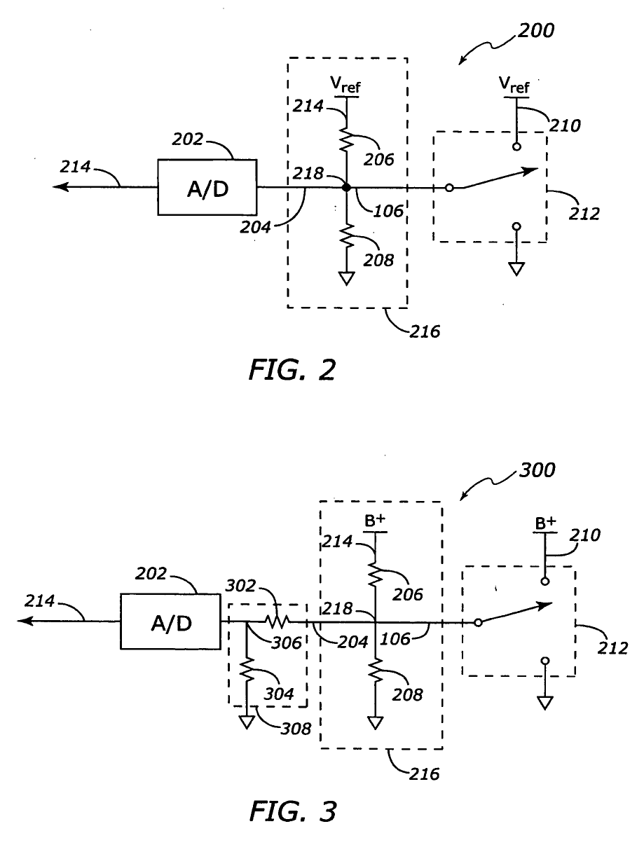

Referring now to FIG. 2, an exemplary switching circuit 200 suitably includes a switch 212, a voltage divider circuit 216 and an analog-to-digital (A/D) converter 202. Switch 212 suitably produces a three-state output that is appropriately transmitted across conductor 106 and decoded at voltage divider circuit 216 and/or A/D converter 202. The circuit 200 shown in FIG. 2 may be particularly useful for embodiments wherein a common reference voltage (V_{ref}) for A/D converter 202 is available to switch 212 and voltage divider circuit 216, although circuit 200 may be suited to array of alternate environments as well.

Switch 212 is any device, circuit or component capable of producing a binary, ternary or other appropriate output on conductor 106. In various embodiments, switch 212 is a conventional double-throw switch as may be commonly found in many vehicles. Alternatively, switch 212 is implemented with a multi-position operator or other voltage selector as appropriate. Switch 212 may be implemented with a conventional three-position low-current switch, for example, as are commonly found on many vehicles. Various of these switches optionally include a spring member (not shown) or other mechanism to bias an actuator 106 (FIG. 1) into a default position, although bias mechanisms are not found in all embodiments. Switch 212 generally corresponds to the various switches 102A-B shown in FIG. 1.

Switch 212 is typically configured to select an output from two reference voltages (such as a high reference voltage (e.g. V_{ref}) and a low reference voltage (e.g. ground)), as well as an intermediate value. In an exemplary embodiment, V_{ref} is the same reference voltage provided to digital circuitry in vehicle 100 (FIG. 1), and may be the same reference voltage provided to A/D converter 202. In various embodiments, V_{ref} is on the order of five volts or so, although other embodiments may use widely varying reference voltages. The intermediate value provided by switch 212 may correspond to an open circuit (e.g. connected to neither reference voltage), or may reflect any intermediate value between the upper and lower reference voltages. An intermediate open circuit may be desirable for many applications, since an open circuit will not typically draw a parasitic current on signal line 106 when the switch is in the intermediate state, as described more fully below. Additionally, the open circuit state is relatively easily implemented using conventional low-current three-position switch contacts 212.

Contacts 212 are therefore operable to provide a ternary signal 106 selected from the two reference signals (e.g. V_{ref} and ground in the example of FIG. 2) and an intermediate state. This signal 106 is provided to decoder circuitry in one or more vehicle components (e.g. components 104, 110 in FIG. 1) as appropriate. In various embodiments, the three-state switch contact 212 is simply a multi-position device that merely selects between the two reference voltages (e.g. power and ground) and an open circuit position or other intermediate condition. The contact is not required to provide any voltage division, and consequently does not require electrical resistors, capacitors or other signal processing components other than simple selection apparatus. In various embodiments, switch 212 optionally includes a mechanical interlocking capability such that only one state (e.g. power, ground, intermediate) can be selected at any given time.

The signals 106 produced by contacts 212 are received at a voltage divider circuit 216 or the like at component 104, 110 (FIG. 1). As shown in FIG. 2, an exemplary voltage divider circuit 216 suitably includes a first resistor 206 and a second resistor 208 coupled to the same high and low reference signals provided to contacts 212, respectively. These resistors 206, 208 are joined at a common node 218, which also receives the ternary signal 106 from switch 212 as appropriate. In the exemplary embodiment shown in FIG. 2, resistor 206 is shown connected to the upper reference voltage V_{ref} 214 while resistor 208 is connected to ground. Resistors 206 and 208 therefore function as pull-down and pull-up resistors, respectively, when signals 106 correspond to ground and V_{ref}. While the values of resistors 206, 208 vary from embodiment to embodiment, the values may be selected to be approximately equal to each other such that the common node is pulled to a voltage of approximately half the V_{ref} voltage when an open circuit is created by contact 212. Hence, three distinct voltage signals (i.e. ground, V_{ref}/2, V_{ref}) may be provided at common node 218, as appropriate. Alternatively, the magnitude of the intermediate voltage may be adjusted by selecting the respective values of resistors 206, 208 accordingly. In various embodiments, resistors 206, 208 are both selected as having a resistance on the order of about 1-50 kOhms, for example about 10 kOhms, although any other values could be used in a wide array of alternate embodiments. Relatively high resistance values may assist in conserving power and heat by reducing the amount of current flowing from V_{ref} to ground, although alternate embodiments may use different values for resistors 206, 208.

The ternary voltages present at common node 208 are then provided to an analog-to-digital converter 202 to decode and process the signals 204 as appropriate. In various embodiments, A/D converter 202 is associated with a processor, controller, decoder, remote input/output box or the like. Alternatively, A/D converter 202 may be a comparator circuit, pipelined A/D circuit or other conversion circuit capable of providing digital representations 214 of the analog signals 204 received. In an exemplary embodiment, A/D converter 202 recognizes the high and low reference voltages, and assumes intermediate values relate to the intermediate state. In embodiments wherein V_{ref} is equal to about five volts, for example, A/D converter may recognize voltages below about one volt as a “low” voltage, voltages above about four volts as a “high” voltage, and voltages between one and four volts as intermediate voltages. The particular tolerances and values processed by A/D converter 202 may vary in other embodiments.

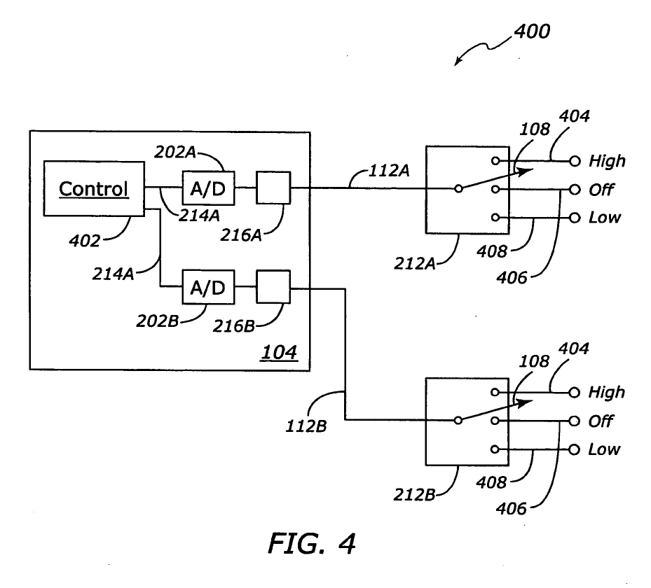

As described above, then, ternary signals 106 may be produced by contacts 212, transmitted across a single carrier, and decoded by A/D converter 202 in conjunction with voltage divider circuit 216. Intermediate signals that do not correspond to the traditional “high” or “low” outputs of contact 212 are scaled by voltage divider circuit 216 to produce a known intermediate voltage that can be sensed and processed by A/D converter 202 as appropriate. In this manner, conventional switch contacts 212 and electrical conduits may be used to transmit ternary signals in place of (or in addition to) binary signals, thereby increasing the amount of information that can be transported over a single conductor. This concept may be exploited across a wide range of automotive and other applications, as described more fully below in conjunction with FIGS. 4-9.

Referring now to FIG. 3, an alternate embodiment of a switching circuit 300 suitably includes an additional voltage divider 308 in addition to contact 212, divider circuit 216 and A/D converter 202 described above in conjunction with FIG. 2. The circuit shown in FIG. 3 may provide additional benefit when one or more reference voltages (e.g. V_{ref}) provided to A/D converter 202 are unavailable or inconvenient to provide to contact 212. In this case, another convenient reference voltage (e.g. a vehicle battery voltage B⁺, a run/crank signal, or the like) may be provided to contact 212 and/or voltage divider circuit 216 as shown. Using the concepts described above, this arrangement provides three distinct voltages (e.g. ground, B₊/2 and B⁺) at common node 204. These voltages may be out-of-scale with those expected by conventional A/D circuitry 202, however, as exemplary vehicle battery voltages may be on the order of twelve volts or so. Accordingly, the voltages present at common node 204 are scaled with a second voltage divider 308 to provide input signals 306 that are within the range of sensitivity for A/D converter 202.

In an exemplary embodiment, voltage divider 308 includes two or more resistors 302 and 304 electrically arranged between common node 208 and the input 306 to A/D converter 202. In FIG. 3, resistor 302 is shown between nodes 208 and 306, with resistor 304 shown between node 306 and ground. Various alternate divider circuits 308 could be formulated, however, using simple application of Ohm's law. Similarly, the values of resistors 302 and 304 may be designed to any value based upon the desired scaling of voltages between nodes 218 and 306, although designing the two resistors to be approximately equal in value may provide improved signal-to-noise ratio for circuit 300.

Using the concepts set forth above, a wide range of control circuits and control applications may be formulated, particularly within automotive and other vehicular settings. As mentioned above, the binary and/or ternary signals 106 produced by contacts 212 may be used to provide control data to any number of vehicle components 104, 110 (FIG. 1). With reference now to FIG. 4, the various positions 404, 406, 408 of contacts 212A-B may be appropriately mapped to various states, conditions or inputs of component 104. As described above, component 104 suitably includes (or at least communicates with) a processor or other controller 402 that includes or communicates with A/D converter 202 and voltage divider circuit 210 to receive ternary signals 112A-B from contacts 212. The digital signals 214 produced by A/D converter 202 are processed by controller 402 as appropriate to respond to the three-state input received at contacts 212. Accordingly, mapping between states 404, 406 and 408 is typically processed by controller 402, although alternate embodiments may include signal processing in additional or alternate portions of system 400. Although FIG. 4 shows an exemplary embodiment wherein controller 402 communicates with two switches 212A-B, alternate embodiments may use any number of switches 212, as described more fully below. The various outputs 214A-B of the switching circuits may be combined or otherwise processed by controller 402, by separate processing logic, or in any other manner, to arrive at suitable commands provided to device 104.

As used herein, state 404 is referred to as ‘1’ or ‘high’ and corresponds to a short circuit to V_{ref}, B⁺ or another high reference voltage. Similarly, state 408 is referred to as ‘0’ or ‘low’, and corresponds to a short circuit to ground or another appropriate low reference voltage. Intermediate state 406 is described as ‘value’ or ‘v’, and may correspond to an open circuit or other intermediate condition of switch 212. In many embodiments, intermediate state 406 is most desirable as a “power off” state, since the open circuit causes little or no current to flow from contacts 212, thereby conserving electrical power. Moreover, an ‘open circuit’ fault is typically more likely to occur than a faulty short to either reference voltage; the most likely faults (open circuits) may therefore result in a less disruptive result, such as turning a feature off rather than leaving the feature ‘stuck’ in an on position should a fault occur. On the other hand, some safety-related features (e.g. headlights) may be configured to remain active in the event of a fault, if appropriate. Accordingly, the various states of contacts 212 described herein may be re-assigned in any manner to represent the various inputs and/or operating states of component 104 as appropriate. The naming and signal conventions used herein are simply for consistency and ease of understanding and may be modified in any manner across a wide array of equivalent embodiments.

Using the concepts of ternary switching, various exemplary mappings of contacts 212 for certain automotive and other applications may be defined as set forth below. Other embodiments may differ from those set forth below, and many additional implementations could be formulated beyond those set forth herein.

Further, the broad concepts of ternary switching can be modified and/or enhanced in any manner. Components that utilize only binary input, for example, could use the third command state provided by circuits 200, 300 above as a diagnostic state. With momentary reference again to FIGS. 2 and 3, if contact 212 provides only binary outputs 106 corresponding to either the high or low reference voltages, voltage divider circuit 216 is still capable of detecting intermediate signals corresponding to open circuits. If the A/D output 214 indicates an intermediate input state, then, it can be readily deduced that this state resulted from an open circuit somewhere in the system. If contact 212 is not configured to produce open circuits, any observed open circuits can indicate a wire break, a fault in switch 212, or another undesirable condition. An indication of an open circuit may therefore be used to trigger a flag, alarm or other indicator as appropriate. Similar concepts could be applied to detect undesired shorts to the high or low reference voltages instead of detecting open circuits.

The concepts described above may be readily implemented to create a multi-state actuator driven control. In such embodiments, two or more switches 102/202 are generally arranged proximate to an actuator 108, with the outputs of the switches corresponding to the various states/positions of the actuator. In various embodiments, the outputs of the switches may be processed using conventional logic gates (e.g. AND/NAND, OR/NOR or the like) or processing circuitry to determine the state of the actuator. Actuator 108 may be guided through the various positions by any mechanical structure.

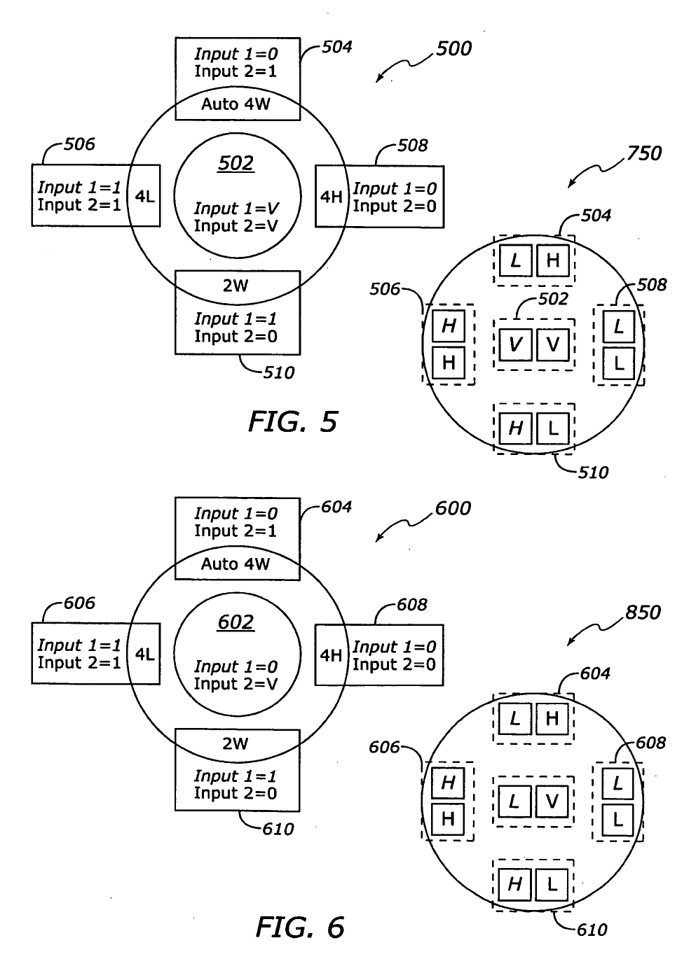

With reference now to FIG. 5, an exemplary switching scheme 500 suitable for use with a 2WD/4WD transfer control suitably includes two switches 102 (INPUT1, INPUT2) configured to detect the position of actuator 108 (FIG. 1) and to thereby determine a desired state for the transfer control. The switching scheme 500 suitably includes five detectable positions 502, 504, 506, 508 and 510 for actuator 108, with position 502 corresponding to the default state.

Diagram 500 shows the respective positions of the various states of actuator 108, with diagram 550 showing corresponding contact settings for indicating when the actuator is in each state. Each of the two contacts 212 in this exemplary embodiment are ternary switches capable of producing three discrete outputs corresponding to “low”, “high” and “value” as described above. Using the assumption that open circuits are more likely to be encountered than shorts to ground, which in turn are more likely than shorts to the battery voltage (B⁺), the exemplary embodiment shown in FIG. 5 could be configured to operate according to the following logic table:

TABLE 1

| State | Input 2 | Input 1 |
|---|---|---|
| 1 | 0 | 0 |
| 2 | 0 | v |
| 3 | 0 | 1 |
| 4 | v | 0 |
| 5 | v | v |
| 6 | v | 1 |
| 7 | 1 | 0 |
| 8 | 1 | v |
| 9 | 1 | 1 |

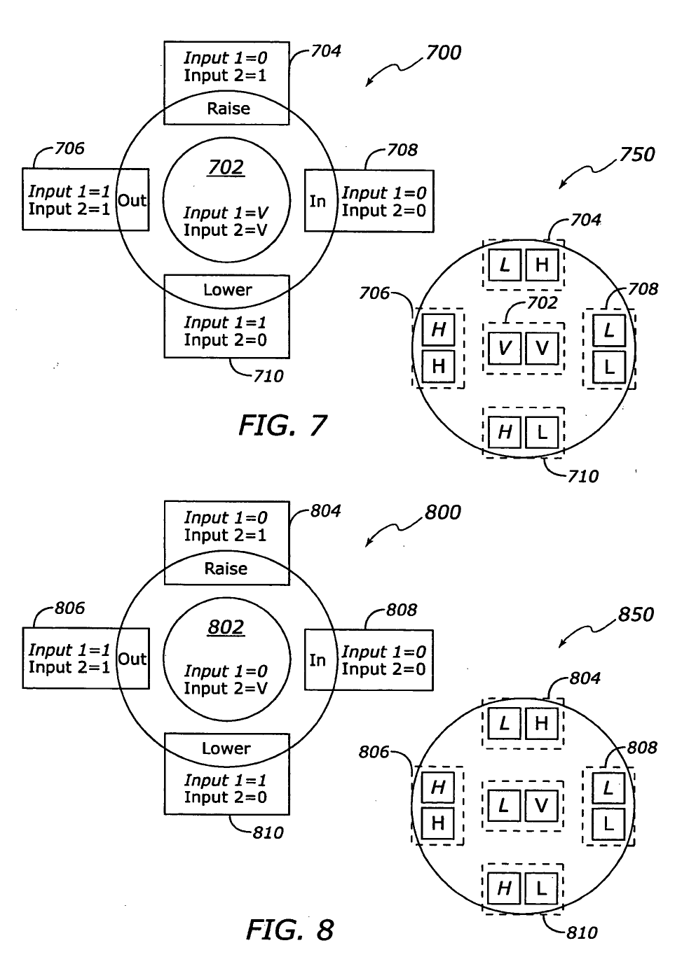

As shown in TABLE 1 and FIGS. 5 and 7, the default position 502/702 is represented by both contacts 212 remaining in the “value” state, which appropriately corresponds to an open circuit. Because very little current flows while the switch is in this state, current consumption is minimized while the actuator is in the default state.

As the operator moves the actuator to indicate desired transitions to other states, the two ternary contacts 212 are actuated and the resulting ternary signals 112 are provided to indicate the current state of the actuator. The state may be determined using conventional logical “AND” constructs, which in turn may be implemented with discrete components, integrated circuitry, software or firmware instructions, and/or in any other manner. As shown in diagram 500, states 1, 3, 5, 7 and 9 of TABLE 1 correspond to the 4H, 2W, default, Auto 4W and 4L positions of the transfer control, respectively. Although other switching schemes could be used in alternate embodiments, by selecting the switching states to correspond to TABLE 1, failures can be minimized since at least two separate failures would be required to improperly transition between states 504 and 510, and/or between states 506 and 508. These state pairs may be appropriately interlocked from each other to further prevent inadvertent transfers from one state to another and to prevent electrical shorts and other performance issues that may arise. Moreover, the control may be made more robust by verifying that actuator 108 moves through default state 502 between any other transitions. Shifting from 4H to 4L, for example, actually involves four switching state transitions (i.e. state 1 (“0-0”) to state 5 (“v-v”), and then state 5 (“v-v”) to state 9 (“1-1”).

TABLE 1 also shows states 2, 4, 6 and 8, which correspond to optional failure states for the transfer control. Although not required in all embodiments, these states can be identified to diagnose shorts or other problems within the switching system. Note that each of the four failure states includes a single “open circuit” reading, meaning if a single “open circuit” is observed, the system may conclude that at least one fault has occurred.

Alternatively, a switching scheme 600 (FIG. 6) may be implemented using a combination of ternary and binary switching logic. With reference now to FIG. 6, an exemplary embodiment of a 2WD/4WD transfer control suitably exhibits five states 602, 604, 606, 608, 610, with 602 representing the default state, and the other states representing Auto 4WD, 4L, 4H and 2WD modes, respectively. Each of the various states are represented with one binary and one ternary signal 112 according to scheme shown in TABLE 2 as follows:

TABLE 2

| State | Input2 | Input1 |
|---|---|---|
| 1 | 0 | 0 |
| 2 | v | 0 |
| 3 | 0 | 1 |
| 4 | 1 | 0 |
| 5 | v | 1 |
| 6 | 1 | 1 |

By comparing diagram 650 to diagram 600 in view of TABLE 2, it can be seen that “state 2” corresponds to default state 602, with states 1, 3, 4 and 6 corresponding to 4HI state 608, 2WD state 610, Auto4W state 604 and 4LO state 606, respectively. State 5 may be used as a diagnostic state, with a “state 5” reading indicating a fault. Alternatively, state 5 could be used as the default setting, and state 2 could be used as a fault state in an alternate embodiment, although the prior embodiment may be more preferable in many applications due the greater likelihood of a faulty short to ground occurring than a faulty short to the higher reference voltage. Like the scheme shown in TABLE 1, this scheme provides dual transitions for states on opposing sides of the default state to minimize unwanted state transitions resulting from faults or the like. This scheme also places at least one open circuit condition at default state 602 to reduce the amount of parasitic current consumed by the switching circuitry. By verifying that actuator 108 transitions through default state 602, additional robustness is added to the system because additional switching state transitions are required to inadvertently register an incorrect position of actuator 108.

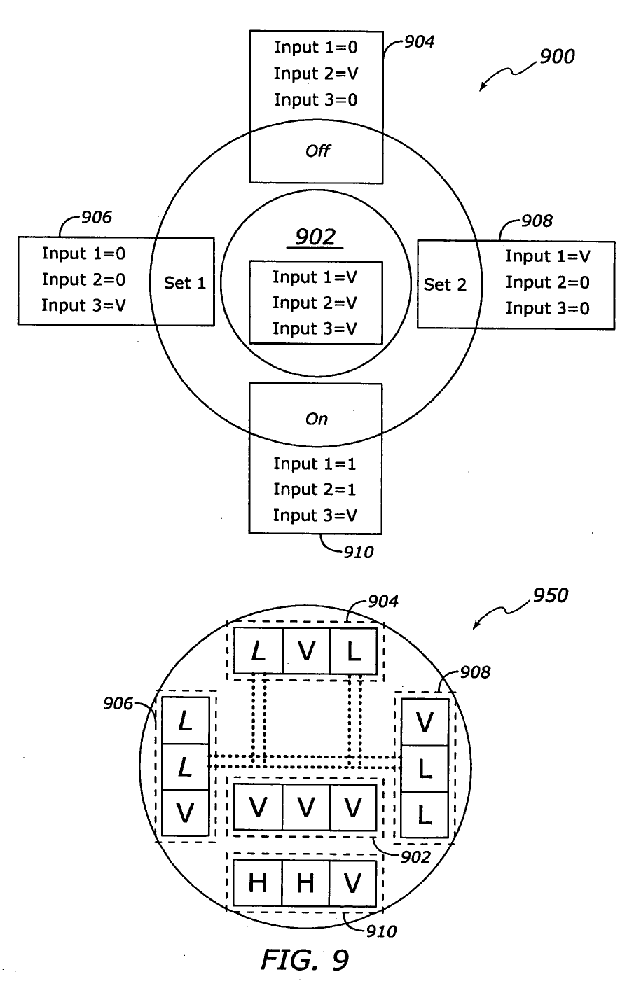

An additional advantage found in various further embodiments using one or more discrete binary switches 102 is that the binary switch need not be physically connected to each state, but may be placed in a “default” high or low state using a pull-up or pull-down resistor to the upper or lower bias voltages, respectively. In the embodiment described in TABLE 2 above, for example, Input1 may be tied to the lower reference voltage (e.g. ground) via a pull-down resistor, thereby eliminating the need to physically couple switch Input1 to states 1, 2 or 3. When the actuator 108 is in default state 602 (“state 2” in Table 2), for example, no electrical contact exists between actuator 108 and Input1 for the proper switching state to register. Conversely, Input1 could be tied to the upper bias voltage with a pull-up resistor to bias the input toward a “high” value and negate the need to couple the switch to states 4, 5 or 6, although this embodiment would not provide the benefit of reducing contacts for the default state. Similar concepts may be applied to other embodiments using binary switches, including the embodiments shown in FIGS. 8 and 13 below.

FIGS. 7 and 8 show exemplary switching schemes suitable for use with a power mirror control. Although the controls may be configured in any manner, the exemplary embodiments shown in FIGS. 7 and 8 generally correspond to FIGS. 5 and 6 and to TABLES 1 and 2, respectively. With reference to FIG. 7, an exemplary scheme 600/650 suitably provides switching and fault detection using at least two ternary switches. States 1, 3, 5, 7 and 9 shown in TABLE 1, for example, generally correspond to the “Mirror In” state 708, “mirror down” state 710, default state 702, “mirror up” state 704 and “mirror out” state 706, respectively. This scheme assures that two electrical failures would be required to result in an opposing state, while providing little or no parasitic current while the switch remains in default state 702 due to the open circuit values of the ternary switches.

FIG. 8 similarly shows a switching scheme for a power mirror control that is based upon one ternary and one binary switch. As discussed above with respect to FIG. 6, this scheme is optimally described by TABLE 2, in which state 2 represents default position 802, and states 1, 3, 4 and 6 corresponding to “mirror in” state 808, “mirror down” state 810, “mirror up” state 804 and “mirror out” state 806, respectively. As mentioned above, the various concepts set forth herein may be readily adapted to any type of single or multiple-axis stick controller, or to any other joystick or other controller in an automotive or other setting. Further, the concepts may be expanded to create additional features and functions in a wide array of equivalent embodiments. Additional robustness may be added to the embodiments shown in FIGS. 7 and 8 by verifying that actuator 108 moves through the default state 702/802 during each transition from state to state.

Additional robustness may be designed into the switching system through any technique. In various embodiments, an additional (e.g. third) contact is provided to further improve the reliability and robustness of the switching scheme. With reference now to FIG. 9, an exemplary robust switching scheme for a power take-off or other device suitably includes three contacts 212, each arranged to provide a ternary output signal 112 corresponding to the position of a mechanical actuator 108. In the exemplary embodiment shown in FIG. 9, actuator 108 can be moved between five states corresponding to default position 902, “off” position 904, “on” position 910, “set1” position 906 and “set2” position 908. For added security, the switch states corresponding to the various positions of the actuator are arranged such that any transition from one state to another requires at least two signal transitions. In such embodiments failures are extremely unlikely, since two separate input failures in the switches or wiring would be required to produce a false state transition. As described above, this robustness may be further enhanced by verifying that actuator 108 moves through default position 902 between each state transition. The switching scheme for the exemplary embodiment of diagram 950 is shown in tabular form below:

TABLE 3

| State | Input3 | Input2 | Input1 |
|---|---|---|---|
| Set2 | 0 | 0 | v |
| Off | 0 | v | 0 |
| Set1 | v | 0 | 0 |
| Default | v | v | v |
| On | v | 1 | 1 |

As shown in TABLE 3, when actuator 108 is in default state 902, all three input switches produce an open circuit to reduce parasitic current flow. Also, TABLE 3 shows that any desired or undesired transition from one state to another would require at least two state changes (in addition to the changes involved in transitioning through the default state), thereby reducing the likelihood of a device failure and improving the safety of the control. Still further, the configuration shown in TABLE 3 has been structured such that the most safety-sensitive transition (e.g. from “off” to “on” and vice versa) is defined with three separate state transactions (e.g. 0-v-0to v-1-1) such that all three switches must change state for the transition to register, thereby inadvertent turn-ons or shut-offs are even less likely.

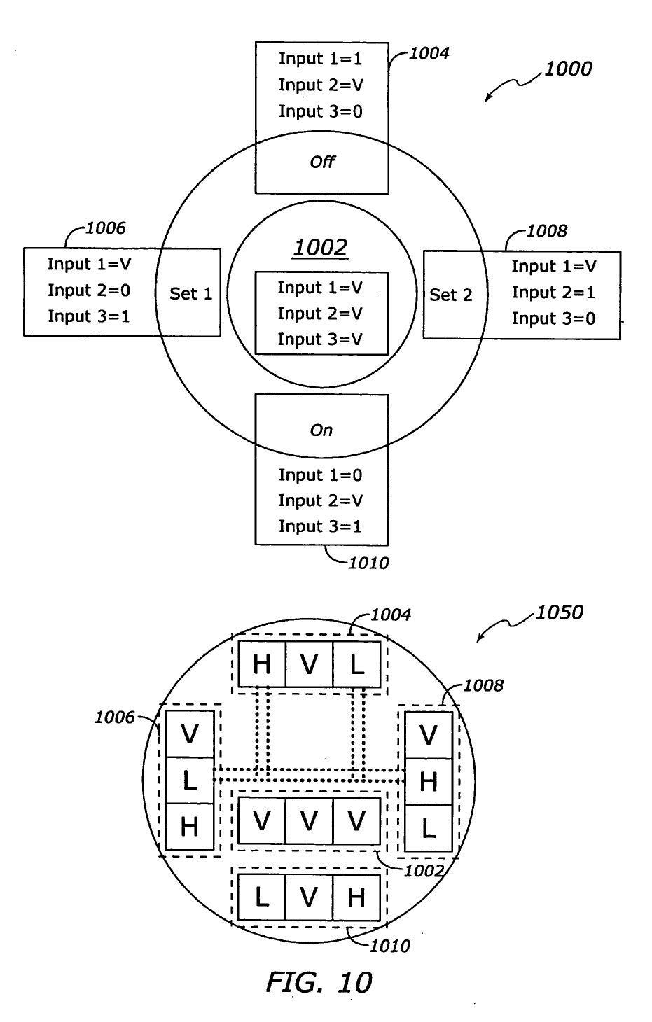

An alternate embodiment of a three-switch, five-state control is shown in FIG. 10. With reference now to FIG. 10, an actuator 108 moves between default state 1002, “off” state 1010, “on” state 1004, “set1” state 1006 and “set2” state 1008. Each state transition produces electrical signals 112 according to TABLE 4:

TABLE 4

| State | Input3 | Input2 | Input1 |
|---|---|---|---|
| Set2 | 0 | 1 | v |
| On | 1 | v | 0 |
| Set1 | 1 | 0 | v |
| Default | v | v | v |
| Off | 0 | v | 1 |

Like the embodiment shown in TABLE 3, each state transition in TABLE 4 requires two relatively simultaneous transitions, thereby reducing the likelihood of a false transition. Moreover, even more robustness is provided by this embodiment, since any accidental transition from the default to another position would require a transition to either a “0” or “1” state, which is much less likely to occur in practice than a transition to an open circuit (“v”). Accordingly, the scheme shown in TABLE 4 is highly robust. This robustness can be further enhanced by verifying that actuator 108 passes through default state 1002 between each other state transition, thereby requiring even more switch transitions.

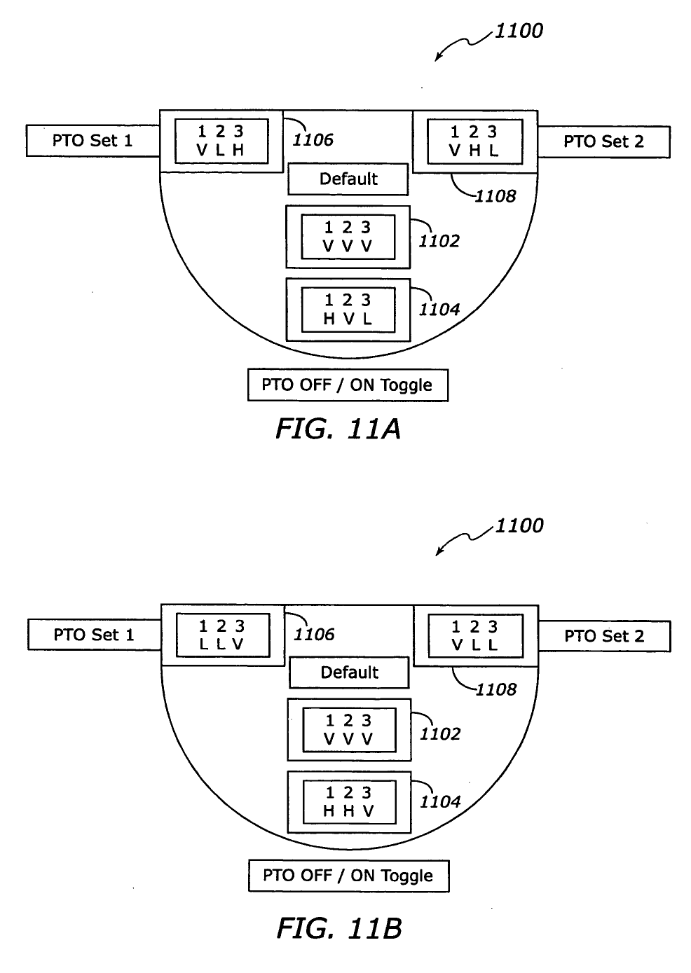

With reference now to FIG. 11A, a first exemplary embodiment of a robust four-state actuator control 1100 suitably process input signals from three switches 102/202 to identify a default position 1102, a “set1” position 1106, a “set2” position 1108 and an On/Off toggle position 1104. In this embodiment, actuator 108 is moved momentarily to position 1104 to toggle the controlled device between an “on” state and an “off” state as appropriate. Alternatively, state 1104 may be used as simply an “off” state, or in any other manner.

To maintain the robustness of the control mechanism, the various actuator states may be assigned as shown in TABLE 5:

TABLE 5

| State | Input3 | Input2 | Input1 |
|---|---|---|---|
| Set2 | 0 | 1 | v |
| Toggle | 0 | v | 1 |
| Default | v | v | v |
| Set1 | 1 | 0 | v |

Alternatively, the various actuator states may be configured as in TABLE 6 without sacrificing robustness. This embodiment is shown in FIG. 11B.

TABLE 6

| State | Input3 | Input2 | Input1 |
|---|---|---|---|
| Set2 | 0 | 0 | v |
| Toggle | v | 1 | 1 |
| Default | v | v | v |
| Set1 | v | 0 | 0 |

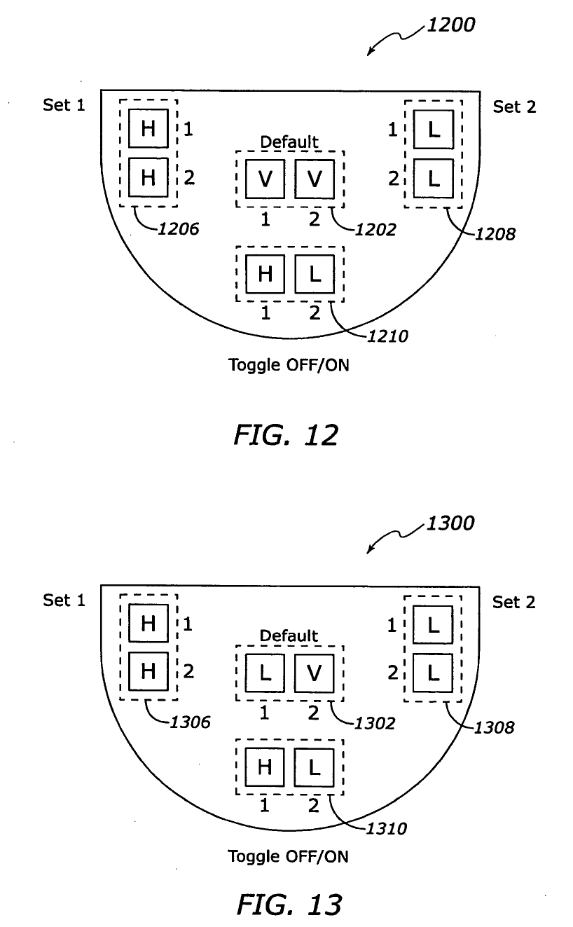

FIGS. 12 and 13 show alternate embodiments of a four-state control 1200, 1300 with a toggle state 1210, 1310. While not as robust as the embodiment shown in FIG. 11, controls 1200 and 1300 may be implemented with fewer switch contacts. As with the prior embodiments, however, robustness may still be provided by verifying that the actuator moves through the default state 1202, 1302 prior to entering a new state.

FIG. 12 shows an exemplary control 1202 formed with two ternary switches 102/202. These switches may be configured similar to the five-state embodiment discussed above in conjunction with FIG. 7, but without a need for either state 704 or 710. Accordingly, the exemplary four-state control shown in FIG. 12 allows the user to toggle a device (e.g. a power take off) on or off by moving actuator 108 from default position 1202 to toggle position 1210. The active device may then be switched between settings SET1 and SET2 by moving actuator 108 between positions 1206 and 1208, respectively. As with the above embodiments, the particular switching arrangements may be modified in any manner. The “toggle” position 1210, for example, may be represented as either “H-L” or “L-H”.

FIG. 13 shows an exemplary control 1302 formed with one ternary switch 102/202 and one binary switch. Like the previous embodiment, control 1302 is similar to the five-state embodiment 800 shown in FIG. 8, but with the removal of one actuator position and corresponding switching state. As shown in FIG. 13, control 1300 suitably provides a default position 1302, a toggle position 1310, and two positions 1306, 1308 that correspond to two operating modes (e.g. SET1, SET2). Like the embodiment shown in FIG. 12, control 1300 may be particularly suited for use in a vehicle power take-off system, but may alternatively be used in any other application. Controls 1200/1300 may be used in a 2WD/4WD transfer control, for example, by simply defining states 1206/1306 and 1208/1308 as “4HI” and “4LO”, and using states 1210/1310 as a 2WD/4WD toggle.

Each of the embodiments described herein may be modified in a variety of ways. Different actuator positions could be logically associated with similar signal combinations, for example, or the various signal combinations could be modified in any manner. The various positions of actuator 108 may be extracted and decoded through any type of processing logic, including any combination of discrete components, integrated circuitry and/or software. Moreover, the various positional and switching structures shown in the figures and tables contained herein may be modified and/or supplemented in any manner.

Although the various embodiments are most frequently described with respect to automotive applications, the invention is not so limited. Indeed, the concepts, circuits and structures described herein could be readily applied in any commercial, home, industrial, consumer electronics or other setting. Ternary switches and concepts could be used to implement a conventional joystick, for example, or any other pointing/directing device based upon four or more directions. The concepts described herein could therefore be readily applied in aeronautical, aerospace, marine or other vehicular settings as well as in the automotive context.

While at least one exemplary embodiment has been presented in the foregoing detailed description, a vast number of variations exist. The various circuits described herein may be modified through conventional electrical and electronic principles, for example, or may be logically altered in any number of equivalent embodiments without departing from the concepts described herein. The exemplary embodiments described herein are intended only as examples, and are not intended to limit the scope, applicability, or configuration of the invention in any way. Rather, the foregoing detailed description will provide those skilled in the art with a convenient road map for implementing one or more exemplary embodiments. Various changes can therefore be made in the functions and arrangements of elements set forth herein without departing from the scope of the invention as set forth in the appended claims and the legal equivalents thereof.

1. A circuit for determining a state of a multi-position actuator, the circuit comprising:
a first switch coupled to the multi-position actuator and configured to provide a first input as a function of the state of the multi-position actuator;
a second switch coupled to the multi-position actuator and configured to provide a second input as a function of the state of the multi-position actuator, wherein the second input is a ternary signal; and
control logic configured to receive the first and second inputs and to determine a state of the multi-position actuator based upon the first and second inputs received.

2. The circuit of claim 1 wherein the ternary signal is selected from a short to a first reference voltage (“0”), a short to a second reference voltage (“1”) and an intermediate state (“v”).

3. The circuit of claim 2 wherein the first input is also selected from a short to the first reference voltage (“0”), a short to the second reference voltage (“1”) and the intermediate state (“v”).

4. The circuit of claim 2 wherein the intermediate state is an open circuit.

5. The circuit of claim 1 wherein the state of the multi-position actuator is selected from five states corresponding to five positions of the multi-position actuator.

6. The circuit of claim 5 wherein one of the five states corresponds to a default position of the multi-position actuator.

7. The circuit of claim 6 wherein the control logic determines the state of the multi-position actuator according to the following table:

| State | Input2 | Input1 |
|---|---|---|
| 1 | 0 | 0 |
| 2 | 0 | v |
| 3 | 0 | 1 |
| 4 | v | 0 |
| 5 | v | v |
| 6 | v | 1 |
| 7 | 1 | 0 |
| 8 | 1 | v |
| 9 | 1 | 1 |

8. The circuit of claim 7 wherein states 1, 3, 5, 7 and 9 correspond to the five states of the multi-position actuator.

9. The circuit of claim 8 wherein state 5 corresponds to the default state of the multi-position actuator.

10. The circuit of claim 8 wherein states 2, 4, 6 and 8 correspond to fault states of the multi-position actuator.

11. The circuit of claim 9 wherein states 1, 3, 7 and 9 respectively correspond to the 4H, 2W, Auto 4W and 4L states of a 2WD/4WD transfer control.

12. The circuit of claim 9 wherein states 1, 3, 7 and 9 respectively correspond to the “In”, “Lower”, “Raise” and “Out” positions of a

13. The circuit of claim 6 wherein the control logic determines the state of the multi-position actuator according to the following table:

| State | Input2 | Input1 |
|---|---|---|
| 1 | 0 | 0 |
| 2 | v | 0 |
| 3 | 0 | 1 |
| 4 | 1 | 0 |
| 5 | v | 1 |
| 6 | 1 | 1 |

14. The circuit of claim 13 wherein states 1, 2, 3, 4 and 6 correspond to the five states of the multi-position actuator, and state 5 is a fault state.

15. The circuit of claim 14 wherein state 2 corresponds to the default state of the multi-position actuator.

16. The circuit of claim 14 wherein states 1, 3, 4 and 6 respectively correspond to the 4H, 2W, Auto 4W and 4L positions of the 2WD/4WD transfer control.

17. The circuit of claim 14 wherein states 1, 3, 4 and 6 respectively correspond to the “In”, “Lower”, “Raise” and “Out” positions of a power mirror control.

18. The circuit of claim 13 wherein the first input is selected from a short to the first reference voltage (“0”), and a short to the second reference voltage (“1”) and wherein the first switch is coupled to the first reference voltage via a pull-down resistor to thereby bias the first switch toward the “0”

19. The circuit of claim 5 further comprising a third input to the control logic, and wherein the five states are as follows:

| State | Input3 | Input2 | Input1 |
|---|---|---|---|
| 1 | 0 | 0 | v |
| 2 | 0 | v | 0 |
| 3 | v | 0 | 0 |
| 4 | v | v | v |
| 5 | v | 1 | 1 |

20. The circuit of claim 19 wherein state 4 is the default state.

21. The circuit of claim 19 wherein states 1, 2, 3 and 5 respectively correspond to the “Set2”, “Off”, “Set1” and “On” positions of a power take-off selector.

22. The circuit of claim 5 further comprising a third input to the control logic, and wherein the five states are as follows:

| State | Input3 | Input2 | Input1 |
|---|---|---|---|
| 1 | 0 | 1 | v |
| 2 | 0 | v | 1 |
| 3 | 1 | 0 | v |
| 4 | v | v | v |
| 5 | 1 | v | 0 |

23. The circuit of claim 22 wherein state 4 is the default state.

24. The circuit of claim 22 wherein states 1, 2, 3 and 5 respectively correspond to the “Set2”, “Off”, “Set1” and “On” positions of a power take-off selector.

25. The circuit of claim 1 wherein the state of the multi-position actuator is selected from four states corresponding to four positions of the multi-position actuator.

26. The circuit of claim 25 further comprising a third input to the control logic, and wherein the four states are as follows:

| State | Input3 | Input2 | Input1 |
|---|---|---|---|
| 1 | 0 | 1 | v |
| 2 | 0 | v | 1 |
| 3 | v | v | v |
| 4 | 1 | 0 | v |

27. The circuit of claim 26 wherein state 3 is the default state.

28. The circuit of claim 26 wherein states 1, 2, and 4 respectively correspond to the “Set2”, “Off/On Toggle” and “Set1” positions of a power take-off selector.

29. The circuit of claim 25 further comprising a third input to the control logic, and wherein the four states are as follows:

| State | Input3 | Input2 | Input1 |
|---|---|---|---|
| 1 | 0 | 0 | v |
| 2 | v | 1 | 1 |
| 3 | v | v | v |
| 4 | v | 0 | 0 |

30. The circuit of claim 25 wherein the four states are as follows:

| State | Input2 | Input 1 |
|---|---|---|
| 1 | 0 | 0 |
| 2 | 0 | 1 |
| 3 | v | v |
| 4 | 1 | 1 |

31. The circuit of claim 25 wherein the four states are as follows:

| State | Input2 | Input 1 |
|---|---|---|
| 1 | 0 | 0 |
| 2 | 0 | 1 |
| 3 | v | 0 |
| 4 | 1 | 1 |

32. The circuit of claim 31 wherein the first input is selected from a short to the first reference voltage (“0”), and a short to the second reference voltage (“1”) and wherein the first switch is coupled to the first reference voltage via a pull-down resistor to thereby bias the first switch toward the “0” state.

33. The circuit of claim 1 wherein the second switch comprises a three-position input device having a first terminal coupled to a first reference voltage and a second terminal coupled to a second reference voltage, wherein the three-position input device is operable to select the second input from the first reference voltage, the second reference voltage and an intermediate state.

34. The circuit of claim 33 wherein the control logic comprises a voltage divider circuit configured to receive the first and second reference voltages and having a common node located therebetween, wherein the voltage divider circuit is configured to receive the second input at the common node and to provide a voltage divider output corresponding to a predetermined voltage when the second input corresponds to the intermediate state, and otherwise to provide the voltage divider output corresponding to the switch output.

35. The circuit of claim 33 wherein the control logic further comprises an analog-to-digital converter configured to receive and decode the voltage divider output to thereby determine the state of the second switch.

36. The circuit of claim 1 wherein the multi-position actuator is a transfer case mechanism.

37. The circuit of claim 1 wherein the multi-position actuator is an electric mirror mechanism.

38. The circuit of claim 1 wherein the multi-position actuator is a power take-off control mechanism.

39. A method of determining a state of a multi-position actuator, the method comprising the steps of:
receiving a first input from a first switch coupled to the multi-position actuator, wherein the first input is determined as a function of the state of the multi-position actuator;
receiving a second input from a second switch coupled to the multi-position actuator, wherein the second input is a ternary signal determined as a function of the state of the multi-position actuator; and
determining a state of the multi-position actuator based upon the first and second inputs received.

40. A four-position device for providing electronic control data to a component, the device comprising:
and actuator configured to move between the four positions in response to user inputs; and
a plurality of switches each configured to provide a ternary input signal corresponding to the position of the actuator to the component.

41. The four-position device of claim 40 wherein the plurality of switches comprises three ternary switches.

42. The four-position device of claim 41 wherein the three ternary switches are configured such that each position transition of the actuator results in at least two of the ternary input signals provided to the component.

43. The four-position device of claim 41 wherein the ternary switches are configured to produce input signals to the component according to the following table:

| State | Input3 | Input2 | Input1 |
|---|---|---|---|
| 1 | 0 | 1 | v |
| 2 | 0 | v | 1 |
| 3 | v | v | v |
| 4 | 1 | 0 | v |

44. The four-position device of claim 43 wherein state 3 is a default state.

45. The four-position device of claim 41 wherein the ternary switches are configured to produce input signals to the component according to the following table:

| State | Input3 | Input2 | Input1 |
|---|---|---|---|
| Set2 | 0 | 0 | v |
| Toggle | v | 1 | 1 |
| Default | v | v | v |
| Set1 | v | 0 | 0 |

46. The four-position device of claim 45 wherein state 3 is a default state.

47. The four-position device of claim 40 wherein the component is a power take-off control for a vehicle.

48. A five-position device for providing electronic control data to a component, the device comprising:
an actuator configured to move between the five positions in response to user inputs; and
a plurality of switches each configured to provide a input signal corresponding to the position of the actuator to the component, wherein at least one of the input signals is a ternary signal.

49. The five-position device of claim 46 wherein the plurality of switcher are configure to produce input signals to the component according to the following table:

| State | Input2 | Input1 |
|---|---|---|
| 1 | 0 | 0 |
| 2 | 0 | v |
| 3 | 0 | 1 |
| 4 | v | 0 |
| 5 | v | v |
| 6 | v | 1 |
| 7 | 1 | 0 |
| 8 | 1 | v |
| 9 | 1 | 1 |

50. The five-position device of claim 46 wherein the plurality of switches are configured to produce input signals to the component according to the following table:

| State | Input2 | Input 1 |
|---|---|---|
| 1 | 0 | 0 |
| 2 | v | 0 |
| 3 | 0 | 1 |
| 4 | 1 | 0 |
| 5 | v | 1 |
| 6 | 1 | 1 |

51. The five-position device of claim 48 wherein Input2 is coupled to a first reference via a pull-down resistor to thereby bias the first switch toward the “0” state.

52. The five-position device of claim 46 wherein the plurality of switches are configured to produce input signals to the component according to the following table:

| State | Input3 | Input2 | Input1 |
|---|---|---|---|
| 1 | 0 | 0 | v |
| 2 | 0 | v | 0 |
| 3 | v | 0 | 0 |
| 4 | v | v | v |
| 5 | v | 1 | 1 |

53. The five-position device of claim 46 wherein the plurality of switches are configured to produce input signals to the component according to the following table:

| State | Input3 | Input2 | Input1 |
|---|---|---|---|
| 1 | 0 | 1 | v |
| 2 | 0 | v | 1 |
| 3 | 1 | 0 | v |
| 4 | v | v | v |
| 5 | 1 | v | 0 |

54. The five-position device of claim 46 wherein the component is a power take-off for a vehicle.

55. The five-position device of claim 46 wherein the component is a power mirror for a vehicle.

56. The five-position device of claim 46 wherein the component is a 2WD/Auto4WD control for a vehicle.

57. The five-position device of claim 46 wherein the plurality of switchers are configure to produce input signals to the component according to the following table:

| State | Input2 | Input 1 |
|---|---|---|
| 1 | 0 | 0 |
| 2 | 0 | v |
| 3 | 0 | 1 |
| 4 | 1 | 0 |
| 5 | 1 | v |
| 6 | 1 | 1 |

58. A device for providing a control signal to a component, the device comprising:
a multi-position actuator means configured to move between a plurality of states;
means for producing a first input as a function of the state of the actuator means;
means for producing a second input signal as a function of the state of the multi-position actuator, wherein the second input signal is a ternary signal; and
means for determining a state of the actuator means based upon the first and second input signals.
